(19) United States
(12) Patent Application Publication
(10) Pub. No.: US 2003/0027930 A1
(43) Pub. Date: Feb. 6, 2003

(54) Polymer-matrix materials and methods for making same

(76) Inventors: Stanley Bruckenstein, Williamsville, NY (US); Irena Jureviciute, Vilnius (LT)

Correspondence Address: Michael L. Goldman, NIXON PEABODY LLP, Clinton Square, P.O. box 31051, Rochester, NY, 14603-1051, US

(21) Appl. No.: 10/200,618

(22) Filed: Jul. 19, 2002

Related U.S. Application Data
(60) Provisional application No. 60/307,066, filed on Jul. 20, 2001.

(51) Int. Cl. C08L 1/00

(52) U.S. Cl. 525/185

(57) ABSTRACT

The present invention relates to a polymer-matrix material including a non-ionic solid matrix and a polymer, wherein the polymer is present on a surface of the non-ionic solid matrix and within an interior bulk of the non-ionic solid matrix. The present invention also relates to methods for forming a polymer within a non-ionic solid matrix. These methods include transporting a polymer precursor or a polymerizing reagent on and into the non-ionic solid matrix and exposing the non-ionic solid matrix to a polymerizing reagent or polymer precursor, respectively, under conditions effective to polymerize the polymer precursor within the non-ionic solid matrix.

This application claims the benefit of U.S. Provisional Application Serial No. 60/307,066, filed Jul. 20, 2001, which is hereby incorporated by reference in its entirety.

### FIELD OF THE INVENTION

The present invention relates generally to methods for forming a polymer, in particular, an electroactive polymer or a conducting polymer, on and within a non-ionic solid matrix and the resulting polymer-matrix material.

### BACKGROUND OF THE INVENTION

Electroactive and conducting polymers can be produced chemically by homogenous chemical reactions. The appropriate monomer is dissolved in a suitable solvent, reagents that cause it to polymerize are added, and the reaction is allowed to proceed. The product of such reactions can be a colloid or a powder if the product is insoluble, a solution if it is soluble, or an emulsion under certain conditions.

A solid matrix may be placed in a reaction mixture for producing an electroactive and conducting polymer. When placed in the reaction mixture, a polymer film may form on the surface of the matrix (see, e.g., Malinauskas, “Chemical Deposition of Conducting Polymers,” Polymer 42:3957-3972 (2001); PCT International Publication No. WO 89/08375 to Hupe et al.; and European Publication No. 0 457 180 A2 to Whitlaw et al.). Such coated matrices are used in several applications, including fabrication of non-thrombogenic substrates, fabrication of conducting plastics, and the treatment of tissue to make it acceptable to the human body.

However, coated matrices produced by present techniques for forming a polymer film on the surface of a solid matrix have been found to lack durability. Thus, such coated matrices are less well suited for long term applications. More specifically, surface films of a polymer tend to flake or wear off with time. Thus, for example, a thrombogenic solid matrix coated with a non-thrombogenic polymer will be accepted by the human body. However, surface layers of the polymer can be removed from the surface of the solid matrix by mechanical abrasion or chemical processes that may occur in the body. This exposes the thrombogenic matrix surface and the likelihood of rejection by the body increases. Thus, the long-term effectiveness of the coated matrix is inadequate. Accordingly, a need remains for a durable, coated solid matrix that can be used, for example, within a human or an animal body.

The present invention is directed to overcoming the above-noted deficiencies in the prior art.

### SUMMARY OF THE INVENTION

The present invention relates to a polymer-matrix material including a non-ionic solid matrix and a polymer, wherein the polymer is present on a surface of the non-ionic solid matrix and within an interior bulk of the non-ionic solid matrix.

The present invention also relates to a method for forming a polymer on and within a non-ionic solid matrix. This method includes transporting a polymer precursor into the non-ionic solid matrix and exposing the non-ionic solid matrix to a polymerizing reagent under conditions effective to polymerize the polymer precursor on and within the non-ionic solid matrix.

Another aspect of the present invention relates to a method for forming a polymer on and within a non-ionic solid matrix which includes transporting a first polymerizing reagent into the non-ionic solid matrix and exposing the non-ionic solid matrix to a polymer precursor under conditions effective to polymerize the polymer precursor on and within the non-ionic solid matrix.

The methods of the present invention allow the formation of a polymer both on the surface of and within a non-ionic solid matrix. Thus, mechanical abrasion or chemical processes will expose the polymer that exists below the surface of the matrix. This makes possible the binding of an electroactive or conducting polymer to organic substrates to produce materials that are durable and will function in hostile environments. In particular, non-thrombogenic organic substrates that will be accepted by the human body over a extended time period may be produced. The methods of the present invention allow the depth of penetration of the polymer and the concentration of the polymer within the non-ionic solid matrix to be controlled.

### DETAILED DESCRIPTION OF THE INVENTION

The present invention relates to a polymer-matrix material including a non-ionic solid matrix and a polymer, wherein the polymer is present on a surface of the non-ionic solid matrix and within an interior bulk of the non-ionic solid matrix.

Suitable non-ionic solid matrices (i.e., matrices which do not include ions) include, but are not limited to, rubber, polypropylene, vinyl (e.g., Tygon™), fluorinated ethylene propylene (FEP), textile fibers, animal tissue, and silica gel. In one embodiment, the solid matrix is organic. In another embodiment, the non-ionic solid matrix is non-conducting. As used herein, the interior bulk of a non-ionic solid matrix is the region of the solid matrix internal to a surface, including a pore surface, of the matrix.

Suitable polymers include electrically conducting polymers and electroactive polymers. An electrically conducting polymer is a polymer that allows charge to flow through it between two points at a different potential (see, e.g., The Encyclopedia of Physics, Reinhold Publishing Company, Bescanon, Ed., New York, p. 127 (1966); Handbook of Conducting Polymers, 2^{nd} Ed., Skotheim et al., Eds., Marcel Dekker, Inc., New York, pp. 27-29 (1998)). In particular, an electrically conducting polymer is a polymer which can be reversibly oxidized and reduced. An electroactive polymer is a polymer that can be oxidized and/or reduced by passing current between it and another conducting phase that can be a source of positive and/or negative charge carriers (see, e.g., Handbook of Conducting Polymers, 2^{nd} Ed., Skotheim et al., Eds., Marcel Dekker, Inc., New York, p. 964 (1998)). Representative electrically conducting and electroactive polymers include, but are not limited to, polypyrrole, polyaniline, polythiophene, and polybithiophene (such polymers are described, for example, in Handbook of Conducting Polymers, 2^{nd} Ed., Skotheim et al., Eds., Marcel Dekker, Inc., New York (1998); U.S. Pat. No. 6,095,148; Electrochemical Science and Technology of Polymers—1, Linford, Ed., Elsevier Applied Science Publishers, Ltd. (b 1987); Electrochemical Science and Technology of Polymers—2, Linford, Ed., Elsevier Applied Science Publishers Ltd. (1990); and Electroactive Polymer Electrochemistry, Part 2, Lyons, Ed., Plenum Press, New York (1996), which are hereby incorporated by reference in their entirety). Suitable polymers also include polymer blends and copolymers of conducting electroactive and/or non-conducting polymers.

In a preferred embodiment, the polymer is polypyrrole or polyaniline or derivatives thereof, which can be made using methods known in the art. Suitable derivatives include substituted polypyrroles or polyanilines, such as N-substituted or 3-substituted (e.g., 3-alkyl substituted) polypyrroles or polyanilines.

In the present invention the polymer is present on the surface and within the interior bulk of the non-ionic solid matrix. The polymer may be chemically bound to the matrix by non-ionic bonds. As known in the art, such non-ionic bonds include covalent bonds, hydrogen bonds, and van der Walls bonds or forces. Alternatively or in addition to chemical bonding, the polymer may be miscible in the solid matrix and present as a solute which is dissolved in the solid matrix. The type of association formed between the polymer and matrix will depend upon the polymer and matrix used.

In one embodiment, the polymer-matrix material includes from about 99 wt. % to about 1 wt. % non-ionic solid matrix and from about 1 wt. % to about 99 wt. % polymer.

In another embodiment, the polymer is present from about 0.1 micrometers within the interior bulk of the non-ionic solid matrix to the center of the non-ionic matrix. The depth of penetration is determined by the application. Low penetration will change the physical properties of the entire matrix the least, while deep penetration is desirable to produce bulk conductivity. In particular, physical properties of the polymer-matrix material, such as surface region conductivity, lubricity, hydrophobicity, hydrophilicity, surface hardness, ability to bond to another material, and flammability, may be altered using a range of penetration depth.

In yet another embodiment, the polymer-matrix material may include other molecules, such as biologically active molecules, which may be incorporated into the polymer. Such molecules and methods for incorporation are described, for example, in Hepel et al., “Effective pH on Ion Dynamics in Composite Polypyyrole/Heparin Films,” Microchemical J., 55:179-191 (1997) and U.S. Pat. No. 6,095,148, which are hereby incorporated by reference in their entirety.

The present invention also relates to a method for forming a polymer on and within a non-ionic solid matrix. This method includes transporting a polymer precursor on and into the non-ionic solid matrix and exposing the non-ionic solid matrix to a polymerizing reagent under conditions effective to polymerize the polymer precursor on and within the non-ionic solid matrix.

Suitable polymer precursors include low molecular weight oligomers, for example, monomers, dimers, and trimers, that will form polymers (e.g., conducting polymers). In particular, suitable polymer precursors include pyrrole and aniline. The polymer precursor may be a pure liquid, a liquid dissolved in solution, or a solid dissolved in solution. Suitable solvents include, but are not limited to, H₂O, CH₂Cl₂, toluene, dimethylsulfoxide (DMSO), acetonitrile, acetone, ethanol, and supercritical fluids, such as CO₂.

According to the present invention, the polymer precursor is transported into the interior bulk of the non-ionic solid matrix. Such transport may occur, for example, by osmotic or capillary action, if the solid matrix is porous, or by partitioning, if the solid matrix is non-porous. As used herein, osmotic action is the transfer of solvent from low concentration solution to high concentration solution (see, e.g, Moore, Physical Chemistry, 4^{th} Ed., Prentice-Hall, New Jersey, pp. 250-253 (1972)), capillary action is the transfer of fluid in a capillary tube (e.g., a pore in a solid matrix) as a result of the relative magnitude of the cohesive forces between fluid molecules and the force of adhesion between the liquid and the walls of the tube (see, e.g., Moore, Physical Chemistry, 4^{th} Ed., Prentice-Hall, New Jersey, pp. 250-253 (1972)), and partitioning is the transfer of a species between two different phases. Preferably, the polymer precursor is transported into the bulk of the non-ionic solid matrix by immersion in liquid polymer precursor or polymer precursor dissolved in a solvent. Typically, immersion time is from about 0.05 hours to about 48 hours.

In this embodiment, the polymer precursor is distributed on and within the non-ionic solid matrix and the non-ionic solid matrix is exposed to a polymerizing reagent, thereby allowing the polymer precursor and polymerizing reagent to react and form a polymer on and within the non-ionic solid matrix. In particular, with an electrically conductive or electroactive polymer, since the surface polymer film that forms initially is a conductor, it can transfer electrons from the polymerizing reagent dissolved in solution to the polymer precursor within the non-ionic solid matrix. Associated with the electron transfer process is a corresponding ionic transfer process that maintains electroneutrality within the polymer that forms on and within the matrix. The corresponding ionic transfer process may include biologically active counter-ions or non-biologically active counter-ions.

Suitable polymerizing reagents include agents that initiate the polymerization process, including, but not limited to, species that produce free radicals without reacting with another species and species that produce free radicals by reacting with another species. In accordance with the present invention, the free radicals initiate the polymerization process. Such polymerizing reagents include, but are not limited to, H₂O₂, K₂S₂O₈, K₂Cr₂O₇, FeCl₃, and tetrachloro-1,4 benzoquinone (chloranil).

In one embodiment, exposing the non-ionic solid matrix to the polymerizing reagent is preferably achieved by immersing the non-ionic solid matrix (with polymer precursor distributed on and within the matrix) in a solution containing the polymerizing reagent. The solvent in the solution should dissolve the polymerizing reagent and itself have some solubility in the polymer. Suitable solvents for the polymerizing reagent include, but are not limited to, H₂O, CH₂Cl₂, toluene, dimethylsulfoxide, acetonitrile, acetone, ethanol, supercritical fluids (e.g., carbon dioxide), aliphatic compounds, aromatic compounds, and halogenated compounds.

In an alternative embodiment of the present invention, the method of the present invention further includes exposing the non-ionic solid matrix to an initial polymerizing reagent prior to said exposing to a polymerizing reagent. Preferably, the initial polymerizing reagent is a weak polymerizing reagent, such as chloranil, and the polymerizing reagent is a stronger polymerizing reagent. The initial polymerizing reagent may be present either in solution with the polymer precursor or as a separate solution to which the solid matrix is exposed prior to the polymerizing reagent.

Preferably, from about 1% to about 100% of the polymer precursor is polymerized. However, the amount of polymerization is determined by the desired use of the polymer-matrix material. In particular, for a polymer-matrix material including a thin bulk region near the surface, 1% polymerization is suitable. For a polymer-matrix material with a uniform distribution of polymer through the bulk of the matrix, up to 100% polymerization would be suitable.

The polymerizing mixture may include other components including, but not limited to, HCl, H₂SO₄, p-toluenesulfonic acid (HTSA), CH₃COOH, CCl₃COOH, poly(sodium 4-styrenesulfonate) (PSSNa), 1,5-naphthalenedisulfonic acid disodium salt, and sulfosalicylic acid. In one embodiment, such additional components may be present with the polymer precursor in solution. In another embodiment, such additional components may be present with the polymerizing reagent in solution. In yet another embodiment, such additional components may be present with both the polymer precursor in solution and the polymerizing reagent in solution.

In order to form, by chemical means, an electrically conducting or electroactive polymer two chemical species react with each other. These are the polymer precursor and the polymerizing reagent. In addition, if the polymerization reaction is to occur, a source or sink of ions must be available to maintain electrical neutrality in all phases that comprise the polymerization system. This source or sink can be the polymer precursor, the polymerizing reagent, and/or a third species such as an acid, base, or a salt.

In a two phase system of a solvent and a matrix, if polymer is to be formed within the matrix, at least one of the required components (the polymer precursor, the polymerizing reagent and/or a third species such as an acid, base, or a salt) must initially be present in the matrix and the others present in another contacting phase, the solvent. The solvent can be one of the three aforementioned components, or another one. When the two phases are brought into contact, polymerization occurs at the interface between the phases. Polymer formation within the matrix occurs as the other two components transfer into the matrix by, for example, partition and diffusion away from the interface, and polymer formation now occurs within the matrix away from the interfacial region and ultimately throughout the bulk of the matrix.

If two of the three required components are initially present in the polymer and the third is present in the solvent, polymerization occurs at the interface when the two phases are brought into contact. Polymer formation within the matrix occurs as the third component transfers into the matrix by, for example, partition and diffusion away from the interface, and polymer formation now occurs within the matrix away from the interfacial region and ultimately throughout the bulk of matrix.

Thus, three conditions must be met. First, a suitable solvent must be one that can dissolve the species are not initially present in the matrix. Second, the solvent must not extract, to a significant extent, species initially present in the matrix. Third, the species initially present in the solvent must not be so soluble in solvent that they have no significant tendency to transfer into the matrix. Consequently, the choice of solvent is dictated by the characteristics of the matrix, the polymer precursor, and the polymerizing reagent. In addition, different solvents can be used to produce the desired result. In particular, one solvent could transfer the polymerizing reagent and another could transfer the polymer precursor.

Another aspect of the present invention relates to a method for forming a polymer on and within a non-ionic solid matrix which includes transporting a first polymerizing reagent on and into the non-ionic solid matrix and exposing the non-ionic solid matrix to a polymer precursor under conditions effective to polymerize the polymer precursor on and within the non-ionic solid matrix.

According to this embodiment of the present invention, the polymerizing reagent is transported into the interior bulk of the non-ionic solid matrix. In particular, the polymerizing reagent is distributed to the desired depth within the non-ionic solid matrix and the non-ionic solid matrix is exposed to a polymer precursor, thereby allowing the polymer precursor and polymerizing reagent to react to form a polymer on and within the non-ionic solid matrix.

In a preferred embodiment, the above method of the present invention further includes, after exposing the non-ionic solid matrix to a first polymer precursor, exposing the non-ionic solid matrix to a second polymerizing reagent. The second polymerizing reagent may be the same as or different than the first polymerizing reagent. In this embodiment, the second polymerizing reagent completes the polymerization of the polymer precursor.

In the methods and material of the present invention, the depth of penetration of the polymer into the non-ionic solid matrix can be controlled. In particular, the depth of penetration of the polymer into the non-ionic solid matrix is controlled by the duration of transport of the polymer precursor or polymerizing reagent into the non-ionic solid matrix, and by the temperature used.

The methods and material of the present invention can be used to treat or produce numerous devices. Such devices include, but are not limited to, prosthetic devices, such as sutures, heart valves, and total artificial hearts, tissue valves (e.g., non-human tissue valves treated to make acceptable to human body), stents, personal computer boards, electrostatic shields, textiles, elastomers, chemical and biological sensors, corrosion inhibiting coatings, gas and liquid separation membranes, electrochemomechanical devices (e.g., artificial muscles), electroluminescent devices, electrical resistors, capacitors, non-ionic matrices with altered surface or bulk properties (such as altered lubricity, hardness, flammability, etc.) and transport conductive coatings (see, also, U.S. Pat. No. 6,095,148, which is hereby incorporated by reference). In accordance with the present invention, the devices are durable and will function in hostile environments. In particular, non-thrombogenic organic substrates that will be accepted by the human body over a extended time period may be produced. In addition, damage caused during installation of such devices will not eliminate the effectiveness of such devices.

### EXAMPLES

### Example 1

### Preparation of Polymer-Matrix With Pyrrole and K₂S₂O₈: Transporting a Polymer Precursor

A rubber sample was submerged overnight in 5 ml pyrrole solution (unless otherwise noted, rubber, vinyl, and polyproplyene samples had about 2 cm² surface area and were 0.1 to 1.5 mm thick). After soaking, the sample was rinsed with distilled water, dried gently with filter paper, and submerged into a 50 ml potassium persulfate solution (10:1 K₂S₂O₈sat in water: concentrated HCl) heated to 65° C. and held at that temperature for 24 hours. Then the sample was put into fresh persulfate solution, heated to the same temperature, and held overnight. After three replicate procedures, the rubber sample had a smooth black polypyrrole surface. The cut surface was totally black throughout. The reference sample of rubber, treated in a similar way at room temperature had a smooth, adherent coating of polypyrrole on the surface and perhaps a few layers below the surface.

### Example 2

### Preparation of Polymer-Matrix With Aniline, Chloranil, and K₂S₂O₈: Transporting a Polymer Precursor

Rubber and vinyl substrates were soaked overnight in aniline. After soaking, the substrates were rinsed with distilled water, dried gently with filter paper, and submerged into a solution comprised of 0.02 mol/l chloranil dissolved in CH₂Cl₂, then rinsed and put into acid aqueous 10:1 K₂S₂O₈sat. and HCl solution. The cut rubber surface was totally black, demonstrating the presence of polyaniline through the bulk of rubber.

### Example 3

### Preparation of Polymer-Matrix With Pyrrole, CH₂Cl₂, and H₂O₂:

Transporting a Polymer Precursor

Several silica gel granules (the average diameter of silica gel particles was 4 to 9 mm) were submerged into 1:1 pyrrole and CH₂Cl₂ solution and left overnight. Then samples were rinsed with distilled water, dried gently with filter paper, and submerged into 50 ml of a solution comprised of 90 vol % H₂O₂ and 10 vol % concentrated HCl solution. After 3 hours, polypyrrole was visible throughout the matrix. Similar results occurred by substituting peroxide with persulfate. Rubber samples obtained in the latter way showed the presence of polypyrrole within the matrix (there were gray, black paths on the surface of cut rubber, but it was not totally black).

### Example 4

### Preparation of Polymer-Matrix With Pyrrole, HTSA, DMSO, Chloranil, and K₂S₂O₈: Transporting a Polymer Precursor

A matrix (rubber, vinyl, or silica gel) sample was submerged overnight in 5 ml 1:1 (pyrrole and 0.05 mol/l HTSA) and DMSO. After soaking, the sample was rinsed with distilled water, wiped gently with filter paper, and submerged for 4 hours in 5 ml of a solution comprised of 0.02 mol/l chloranil dissolved in CH₂Cl₂, then rinsed. Subsequently, the matrix was dried with filter paper and submerged overnight in an aqueous solution comprised of 90 vol % K₂S₂O₈sat. in H₂O and 10 vol % concentrated HCl. Then the matrix was rinsed with distilled water and dried in air. Polypyrrole formed throughout the bulk of the matrix.

### Example 5

### Preparation of Polymer-Matrix With Pyrrole, Chloranil, and K₂S₂O₈: Transporting a Polymer Precursor

A rubber matrix was submerged overnight in 5 ml of a solution comprised of 0.02 mol/l chloranil dissolved in pyrrole (the solution turned brown, presumably due to partial pyrrole polymerization). Following the rinsing and drying procedure described in Example 1, the matrix was submerged into the above-described acid potassium persulfate solution of Example 4. A good, smooth, black adherent surface formed. There was polypyrrole within the matrix.

### Example 6

### Preparation of Polymer-Matrix With Aniline, HTSA, and K₂S₂O₈: Transporting a Polymer Precursor

A rubber or a vinyl matrix was submerged overnight in 5 ml of a solution comprised of 0.05 mol/l HTSA dissolved in aniline. Following the rinsing and drying procedure described in Example 1, the matrix was submerged into the acid potassium persulfate solution of Example 4. A smooth black adherent surface formed. There was polyaniline within the matrix.

### Example 7

### Preparation of Polymer-Matrix With Aniline, HTSA, and, optionally, K₂S₂O₈: Transporting a Polymer Precursor

A rubber matrix was submerged overnight in 5 ml of the above-mentioned aniline and 0.05 mol/l HTSA solution of Example 6. Following the rinsing and drying procedure described in Example 1, the matrix was submerged into the acid potassium persulfate solution of Example 4 or the 0.05 mol/l HTSA solution. A smooth black adherent surface with powdery overlayer formed. There was polyaniline within the matrix in all cases.

### Example 8

### Preparation of Polymer-Matrix With Aniline, CH₂Cl₂, HTSA, and K₂S₂O₈: Transporting a Polymer Precursor

A rubber matrix was submerged overnight in 5 ml of a solution comprised of 0.05 mol/l HTSA dissolved in 1:1 aniline and CH₂Cl₂. Following the rinsing and drying procedure described in Example 1, the matrix was submerged into the acid potassium persulfate solution of Example 4. A smooth black adherent surface formed. There was polyaniline within the matrix, and its cut surface was dark. Left in the air the cut surface turned black.

### Example 9

### Preparation of Polymer-Matrix With Pyrrole, Toluene, and K₂S₂O₈: Transporting a Polymer Precursor

A rubber matrix was treated as described in Example 8 above. It was soaked overnight in 5 ml of a 50 vol % pyrrole and 50 vol % toluene solution and then after the rinsing procedure described in Example 1, the matrix was submerged into 50 ml of a solution comprised of 0.05 mol/l of HTSA dissolved in saturated, aqueous K₂S₂O₈ and left overnight. The surface showed traces of polypyrrole and it turned black when put into an acid aqueous saturated persulfate solution. After drying this sample in air for two months, the rubber sample was dark within the whole matrix (the same result was obtained using K₂Cr₂O₇ instead of K₂S₂O₈).

### Example 10

### Preparation of Polymer-Matrix With Pyrrole or Aniline, Toluene, HTSA, and FeCl₃: Transporting a Polymer Precursor

A rubber matrix was submerged in 5 ml 1:1 pyrrole or aniline and toluene and 0.05 mol/l HTSA and left overnight. Then the matrix was submerged in a 90 vol % saturated, aqueous FeCl₃ solution and 10 vol % concentrated HCl overnight. The fresh cut surface showed only traces of polypyrrole inside the rubber. But, after aging in air, the polymerization continued further. The same pattern occurred in samples soaked in pyrrole and aniline that was treated in acid potassium dichromate polymerizing solution.

### Example 11

### Preparation of Polymer-Matrix With Pyrrole, Toluene, DMSO, K₂Cr₂O₇, and HTSA: Transporting a Polymer Precursor

A rubber matrix was submerged in 33⅓ vol % pyrrole, 33⅓ vol % toluene, and 33⅓ vol % DMSO and was kept overnight. Then the matrix was submerged in a solution comprised of 0.05 mol/l HTSA dissolved in a mixture of 50 vol % concentrated HCl and 50 vol % saturated, aqueous K₂Cr₂O₇ and kept again overnight. An adherent black coat was observed. The sample was cut two months after preparation, and the cut surface was brown.

### Example 12

### Preparation of Polymer-Matrix With Toluene, Poly(sodium 4-styrenesulfonate)), Pyrrole or Aniline, and K₂S₂O₈: Transporting a Polymerizing Reagent

A rubber or vinyl matrix was submerged in toluene and poly(sodium 4-styrenesulfonate)) (PSSNaₛₐₜ) (in toluene), and soaked overnight. Next, following the washing and drying procedure described above, the sample was put into 100% pyrrole or 100% aniline for 5 hours. Again, after the above-described washing and drying procedure, the matrix was submerged into 50 ml 10:1 K₂S₂O₈sat. in H₂O and HCl and left overnight. The cut rubber surface was blackish. The vinyl sample was glossy black throughout.

### Example 13

### Preparation of Polymer-Matrix With Toluene, Chloranil, Pyrrole and K₂S₂O₈: Transporting a Polymerizing Reagent

A matrix (rubber, vinyl, fluorinated ethylene propylene (FEP)) was soaked overnight in a solution comprised of 0.05 mol/l of chloranil dissolved in toluene. Then the matrix was rinsed with distilled water, dried gently with filter paper, and submerged for 3 hours in 5 ml of pyrrole. The matrix was then rinsed with distilled water, dried with filter paper, and submerged overnight in 50 ml of an aqueous solution comprised of 10 vol. % of saturated, aqueous K₂S₂O₈ and 1 vol. % of concentrated HCl. The cut surface of the rubber was dark. The vinyl sample was totally black throughout, and became hard.

### Example 14

### Preparation of Polymer-Matrix With Toluene, Chloranil, and Pyrrole: Transporting a Polymerizing Reagent

A matrix (vinyl) was held overnight in a solution comprised of 0.05 mol/l chloranil dissolved in toluene. Then the matrix was rinsed with distilled water, dried gently with filter paper, and submerged for 3 hours in 100% pyrrole. The matrix was then rinsed with distilled water, dried with filter paper, and submerged overnight in above-described toluene and 0.05 mol/l chloranil solution. The vinyl sample had a dark brown adherent clear coat. It was hard, but cut easily. The cut surface was initially dark, and after a week in air, it was totally black.

### Example 15

### Preparation of Polymer-Matrix With Toluene, Chloranil, Poly(sodium 4-styrenesulfonate)), Pyrrole or Aniline, and K₂S₂O₈: Transporting a Polymerizing Reagent

A matrix (rubber, polypropylene, vinyl, or FEP) sample, with an area of about 1 cm and a thickness of about 1 mm, was soaked overnight in a solution comprised of 0.05 mol/l chloranil dissolved in toluene that was saturated with PSSNa. Then the matrix was rinsed with distilled water, dried gently with filter paper, and submerged for 3 hours in 5 ml of pyrrole or aniline. The matrix was then rinsed with distilled water, dried with filter paper, and submerged overnight in 50 ml of an aqueous solution comprised of 90 vol. % of saturated, aqueous K₂S₂O₈ and 10 vol. % of concentrated HCl. The cut surface of the rubber was dark. The vinyl sample was totally black throughout, and it was hard.

### Example 16

### Preparation of Polymer-Matrix With CH₂Cl₂, CCl₃COOH, Pyrrole or Aniline, and K₂S₂O₈: Transporting a Polymerizing Reagent

A matrix (rubber, polypropylene, or vinyl) was soaked overnight in a solution comprised of 0.5 mol/l CCl₃COOH dissolved in CH₂Cl₂. Then the matrix was rinsed with distilled water, dried gently with filter paper, and submerged for 5 hours in 100% pyrrole or 100% aniline. The matrix was then rinsed with distilled water, dried with filter paper, and submerged overnight in 50 ml of an aqueous solution comprised of 90 vol. % of saturated, aqueous K₂S₂O₈ and 10 vol. % of concentrated HCl. The cut surface of the rubber was dark brown. The vinyl sample was totally black throughout, and it was hard. The polypropylene surface was totally black, was dense and smooth, and the cut surface was clear yellowish/brown.

### Example 17

### Preparation of Polymer-Matrix With CH₂Cl₂, Poly(sodium 4-styrenesulfonate)), Aniline, and K₂S₂O₈: Transporting a Polymerizing Reagent

A matrix (rubber, polypropylene, or vinyl) was soaked overnight in a solution comprised of 0.05 mol/l PSSNa dissolved in CH₂Cl₂. Then the matrix was rinsed with distilled water, dried gently with filter paper, and submerged for 5 hours in 100% aniline. The matrix was then rinsed with distilled water, dried with filter paper, and submerged overnight in an aqueous solution comprised of 90 vol. % of saturated, aqueous K₂S₂O₈ and 10 vol. % of concentrated HCl. The cut surface of the rubber was dark brown. The vinyl sample was totally black throughout, and had become hard. The polypropylene surface was totally black, was dense and smooth, and its cut surface was clear yellowish/brown.

### Example 18

### Preparation of Polymer-Matrix With CH₂Cl₂, HTSA, Aniline, and K₂S₂O₈: Transporting a Polymerizing Reagent

A matrix (rubber, polypropylene or vinyl) was soaked overnight in 5 ml CH₂Cl₂+HTSA sat. solution. Then the matrix was rinsed with distilled water, dried gently with filter paper, and submerged overnight in 5 ml of aniline. The matrix was then rinsed with distilled water, dried with filter paper, and submerged for 8 hours in 50 ml of an aqueous solution comprised of 10 vol. % of saturated, aqueous K₂S₂O₈ and 1 vol. % of concentrated HCl. The cut surface of the rubber was dark. The vinyl sample was totally black throughout and was hard. The polypropylene surface was totally black, was dense and smooth, and the cut surface was clear brown. The surface of cut rubber-polyaniline was all brown.

### Example 19

### Preparation of Polymer-Matrix With CH₂Cl₂, Chloranil, Pyrrole or Aniline, and K₂S₂O₈: Transporting a Polymerizing Reagent

A matrix (rubber, vinyl) was soaked overnight in 5 ml CH₂Cl₂ and 0.02 mol/l chloranil solution. Then the matrix was rinsed with distilled water, dried gently with filter paper, and submerged for 5 hours in 5 ml of pyrrole or aniline. The matrix was then rinsed with distilled water, dried with filter paper, and submerged overnight in 50 ml of an aqueous solution of saturated K₂S₂O₈.

### Example 20

### Preparation of Polymer-Matrix With CH₂Cl₂, Chloranil, Pyrrole or Aniline, and K₂S₂O₈: Transporting a Polymerizing Reagent

A matrix (rubber, vinyl) was held overnight in 5 ml CH₂Cl₂ and 0.02 mol/l chloranil solution. Then the matrix was rinsed with distilled water, dried gently with filter paper, and submerged for 5 hours in 5 ml of pyrrole or aniline. The matrix was then rinsed with distilled water, dried with filter paper, and submerged overnight in 5 ml CH₂Cl₂ and 0.02 mol/l chloranil solution and then again in pyrrole or aniline. Finally, the process was finished by submerging the matrix in 50 ml aqueous solution of saturated K₂S₂O₈.

### Example 21

### Preparation of Polymer-Matrix With Pyrrole or Aniline and K₂S₂O₈: Transporting a Polymer Precursor

A porcine tissue sample was exposed to 5 ml pyrrole or aniline. Then the sample was submerged in a 50 ml aqueous solution of 10:1 K₂S₂O₈sat and HCl. The fresh cut surface was not black throughout, but was more brown. After keeping it in air (sealed beaker) for 3 days the sample became black all the way through the tissue. In the case of aniline, the cut surface was dark brown.

### Example 22

### Preparation of Polymer-Matrix With Pyrrole, DMSO, and K₂S₂O₈: Transporting a Polymer Precursor

A porcine tissue sample was exposed to 5 ml 1:1 pyrrole and DMSO. Then the sample was submerged in a 50 ml aqueous solution comprised of 90 vol. % of saturated, aqueous K₂S₂O₈ and 10 vol. % of concentrated HCl. The fresh cut surface was not black throughout, but was more brown. After keeping it in air (sealed beaker) for 3 days, the sample became black almost all the way through the tissue.

### Example 23

### Preparation of Polymer-Matrix With Pyrrole, Toluene, and K₂S₂O₈: Transporting a Polymer Precursor

A porcine tissue sample was exposed to a solution comprised of 50 vol. % pyrrole or aniline and 50 vol. % DMSO. Then the sample was submerged in 50 ml of aqueous solution containing 3 g FeCl₃ and 2 ml concentrated HCl and 0.75 g 1.5-naphthtalenedisulfonate disodium salt. The fresh cut surface was not black throughout, but was more light blue. After keeping it in air (sealed beaker) for 3 days, the pyrrole-treated sample became dark gray blue all the way through the tissue. The aniline-treated sample was black outside and was greenish blue through the whole sample.

### Example 24

### Preparation of Polymer-Matrix With Toluene, Chloranil, Poly(sodium 4-styrenesulfonate)), Pyrrole or Aniline, and K₂S₂O₈: Transporting a Polymerizing Reagent

A porcine tissue sample was exposed to 5 ml toluene and 0.05 mol/l chloranil and PSSNaₛₐₜ. Then the sample was submerged in 100% pyrrole or 100% aniline, rinsed with distilled water, dried gently with filter paper, and submerged in the previously described 50 ml aqueous solution of 10:1 K₂S₂O₈sat and HCl. The aniline-treated sample was dark brown, almost black through the whole sample. The pyrrole-treated sample still had brown color when cut, and had more than surface polymerization.

### Example 25

### Preparation of Polymer-Matrix With Toluene, Chloranil, p-toluenesulfonic acidₛₐₜ, Pyrrole, and K₂S₂O₈: Transporting a Polymerizing Reagent

A porcine tissue sample was exposed to a solution comprised of 0.05 mol/l chloranil and 0.1 mol/l p-toluenesulfonic acid dissolved in toluene. Then the sample was submerged in 100% pyrrole, rinsed with distilled water, dried gently with filter paper, and submerged in an aqueous solution comprised of 90 vol. % of saturated, aqueous K₂S₂O₈ and 10 vol. % of concentrated HCl. The pyrrole-treated sample was gray, blueish throughout the whole sample, with more than just surface polymerization.

### Example 26

### Preparation of Polymer-Matrix With CH₂Cl₂, Chloranil, Pyrrole or Aniline, and K₂S₂O₈: Transporting a Polymerizing Reagent

A porcine tissue sample was exposed to a solution comprised of 0.05 mol/l chloranil dissolved in CH₂Cl₂. Then the sample was submerged in 100% pyrrole or 100% aniline, rinsed with distilled water, dried gently with filter paper, and submerged in a 50 ml aqueous solution comprised of 90 vol. % of saturated, aqueous K₂S₂O₈ and 10 vol. % of concentrated HCl. The fresh aniline-treated sample's cut surface was light brown inside. The pyrrole-treated sample was gray inside when cut, with more than just surface polymerization.

### Example 27

### Preparation of Polymer-Matrix With Toluene, Chloranil, Poly(sodium 4-styrenesulfonate)), Pyrrole or Aniline, and K₂S₂O₈: Transporting a Polymerizing Reagent

A porcine tissue sample was exposed to a solution comprised of 0.05 mol/l chloranil and 0.5 mol/l CCl₃COOH dissolved in CH₂Cl₂. Then the sample was submerged in 100% pyrrole or 100% aniline, rinsed with distilled water, dried gently with filter paper, and submerged in an aqueous solution comprised of 90 vol. % of saturated, aqueous K₂S₂O₈ and 10 vol. % of concentrated HCl. The fresh sample's cut surface was brown inside. When kept in a sealed beaker for 3 days, the aniline-treated sample became dark brown when cut and the pyrrole-treated sample was a lighter brown.

### Example 28

### Preparation of Rubber-Polypyrrole Materials Using Pyrrole: Comparison of Polymerizing Reagents

A rubber substrate was soaked overnight in 100% pyrrole. After soaking, the sample was rinsed with distilled water, dried gently with filter paper, and submerged into one of the following solutions: 30% H₂O₂ and then exposed HCl vapor; 90 vol. % of 30% H₂O₂ and 10 vol. % of concentrated HCl; saturated, aqueous K₂S₂O₈; 90 vol. % of saturated aqueous K₂S₂O₈ and 10 vol. % of concentrated HCl; half saturated, aqueous K₂S₂O₈, and half saturated, aqueous PSSNa, and 1 mol/l HCl; half saturated, aqueous K₂CrO₄; half saturated, aqueous K₂CrO₄ and 1 mol/l HCl; half saturated, aqueous K₂CrO₄, 0.05 mol/l HTSA and 1 mol/l HCl; 1/10^{th} saturated FeCl₃; 1/10^{th} saturated, aqueous FeCl₃ and 1 mol/l HCl; 1/10^{th} saturated, aqueous Fe₂(SO₄)₃ and 0.1 mol/l H₂SO₄; 1/10^{th} saturated, aqueous Fe₂(SO₄)₃ and 1 mol/l HCl; or 1/10^{th} saturated, aqueous K₃(FeCN)₆ and 1/10^{th} saturated, aqueous ZnCl₂ and 1 mol/l HCl. For H₂O₂, no visible polymerization within a day was observed. For HCl vapor, the rubber lost elasticity, becoming only slightly elastic. A black adherent coating was observed and the cut surface was not white, but was light yellow, brownish. For H₂O₂ and HCl, the process was slow in comparison with acidified dichromate or persulfate. The rubber surface was smooth, with polypyrrole not far into the surface, but was not stable when left in the oxidizing solution. Oxidation occurred in saturated, aqueous K₂S₂O₈. The rubber coating was smooth, with mainly surface polymerization. For the K₂S₂O₈ and HCl solution, the polymerization proceeded faster than with the saturated, aqueous K₂S₂O₈. A smooth polypyrrole film was produced with no through conductivity or permeation. Filter paper coated the same way showed some conductivity when dried. In the K₂S₂O₈, HCl, and PSSNa solution, a fast polymerization occurred. Well attached surface polypyrrole was observed and the rubber was flexible. The cut surface was not black. In half saturated aqueous K₂Cr₂O₇, no polypyrrole was observed after two days. In the K₂Cr₂O₇ and HCl solution, the polymerization was slower than an acid persulfate. Well attached surface polypyrrole was observed, however, the inside of the rubber had no polymer. In the K₂Cr₂O₇, HCl, and HTSA solution, more polypyrrole was observed, and it was well attached with a powdery overlayer on the rubber. The cut surface was rubber colored. In aqueous FeCl₃, the process was slow. In the FeCl₃ and HCl solution, the process was slower than in acidified peroxide, dichromate, or persulfate solutions. The film was smooth, but not thick. The color was blue-pink, rather than black. In the Fe₂(SO₄)₃ and H₂SO₄ solution, the process was very slow. The film that formed was brown and thin. In the Fe₂(SO₄)₃ and HCl solution, the process was not much different from Fe₂(SO₄)₃ acidified by sulfuric acid. The film's color was more blue-green. In the K₃Fe(CN)₆, HCl, and ZnCl₂ solution, the process was slow and produced a thin film. Very little, if any, coating on glass and ceramics was observed.

### Example 29

### Preparation of Rubber-Polypyrrole Materials Using Pyrrole and HTSA: Comparison of Polymerizing Reagents

The substrate, rubber, was soaked overnight in pyrrole containing p-toluenesulfonic acid (HTSA) and then soaked in one of the following solutions: saturated, aqueous K₂S₂O₈; 90 vol. % of saturated, aqueous K₂S₂O₈ and 10 vol. % of concentrated HCl; saturated, aqueous K₂S₂O₈ and 0.05 mol/l HTSA; or 0.05 mol/l HTSA in 1 molar aqueous HCl saturated with K₂S₂O₈. In aqueous K₂S₂O₈ solution, a black, adherent film was formed on flexible rubber. The inside of the substrate was white, and a lot of polypyrrole was formed in the solution. In the K₂S₂O₈ and HCl solution, an adherent surface film and flexible rubber was observed. The freshly cut surface was whitish/pink. In the K₂S₂O₈ and HTSA solution, an adherent surface film on flexible rubber was formed. The freshly cut surface was white. When put into acid persulfate solution, the cut surface became dark. In the K₂S₂O₈ and HCl and HTSA solution, an adherent surface film on flexible rubber was formed. The freshly cut surface was white.

### Example 30

### Preparation of Rubber-Polypyrrole Materials Using Pyrrole and CH₂Cl₂: Comparison of Polymerizing Reagents

Rubber or silica gel substrates, were soaked overnight in a 1:1 dichloromethane solution of pyrrole, then soaked in the following solutions: 90 vol. % of 30% H₂O₂ and 10 vol. % of concentrated HCl; half saturated, aqueous K₂CrO₄ and 1 mol/l HCl; or 90 vol. % of saturated, aqueous K₂S₂O₈ and 10 vol. % of concentrated HCl. In the acidified H₂O₂ with the rubber substrate, an adherent surface coating was observed and the cut surface showed black paths through the rubber (which was flexible). In the acidified H₂O₂ solution with the silica gel substrate, polypyrrole formed throughout the bulk. The substrate was not brittle, but it broke easily. The substrate was black inside. In the acid K₂Cr₂O₇ solution, the substrate became black inside. The results were better than peroxide samples. On a previously cut surface, black paths formed in the rubber. The fresh cut surface of the rubber was gray. For the K₂S₂O₈ and HCl solution with the rubber substrate, an adherent surface coating was observed and the cut surface showed black paths through the rubber. This sample gave the best results of the three tested solutions.

### Example 31

### Preparation of Rubber-Polypyrrole Materials Using Pyrrole and CH₃COCH₃: Comparison of Polymerizing Reagents

The substrates, rubber or silica gel, were soaked overnight in a 1:1 acetone solution of pyrrole and then were soaked in the same solutions as in Example 30. In all cases, the results were better than with the pyrrole and CH₂Cl₂ solution. Also, the results with persulfate were better than with dichromate, which was better than peroxide.

### Example 32

### Preparation of Rubber-Polypyrrole Materials Using Pyrrole and DMSO: Comparison of Polymerizing Reagents

The substrates, rubber or silica gel, were soaked overnight in a 1:1 dimethyl sulfoxide (DMSO) solution of pyrrole and then soaked in the same solutions as in Example 30. The results were better than with 1:1 pyrrole and CH₂Cl₂ or 1:1 pyrrole and CH₃COCH₃. Also, the results with persulfate were better than with dichromate, which was better than peroxide.

### Example 33

### Preparation of Rubber-Polypyrrole Materials Using Pyrrole and CH₃COOH: Comparison of Polymerizing Reagents

The substrate, rubber, was soaked overnight in a 1:1 glacial acetic acid solution of pyrrole and then soaked in the following solutions: half saturated, aqueous K₂Cr₂O₇ and 8 mol/l CH₃COOH or saturated, aqueous K₂S₂O₈. In the K₂Cr₂O₇ and CH₃COOH solution, the rubber formed an adherent black coat, the cut surface was light brown, and the substrate was a bad conductor. In saturated, aqueous K₂S₂O₈ solution, the results were the same as for K₂Cr₂O₇ and CH₃COOH. However, the structure of the rubber changed after the soaking in the acetic acid solution

### Example 34

### Preparation of Rubber-Polypyrrole Materials Using Pyrrole, HTSA, and DMSO: Comparison of Polymerizing Reagents

The substrate, rubber, was soaked overnight in a 1:1 dimethylsulfoxide solution of (pyrrole+HTSA), and then soaked in the following solutions: 90 vol. % of 30% H₂O₂ and 10 vol. % of concentrated HCl; 90 vol. % of saturated, aqueous K₂S₂O₈ and 10 vol. % of concentrated HCl; half saturated, aqueous K₂CrO₄ and 1 molar HCl; saturated, aqueous K₂S₂O₈ and 0.05 mol/l HTSA; half saturated, aqueous K₂CrO₄ and 0.05 mol/l HTSA; or a solution comprised of 0.02 mol/l chloranil dissolved in CH₂Cl₂ and then saturated, aqueous K₂S₂O₈. The best results, compared to the previous Examples, for surface conductivity were obtained holding rubber in these solutions and polymerizing afterwards in acid persulfate or dichromate. There was also some surface to surface conductivity. Using the H₂O₂ and HCl solution gave better results than the previous Examples. Using the K₂S₂O₈ and HCl solutions gave better results than with peroxide and all previous Examples. The K₂Cr₂O₇ and HCl solution gave better results than the previous Examples, but worse than the persulfate polymerization schemes. The K₂S₂O₈ and HTSA solution gave a good adherent black coating on rubber. The fresh cut surface was definitely darker than virgin rubber. The cut surface turned black in K₂S₂O₈ and HTSA and also darkened on exposure to air. The K₂Cr₂O₇ and HTSA solution gave results that were worse than with persulfate. The cut surface was just slightly gray. Subsequent treatment in acidified K₂S₂O₈ gave much better results. Soaking in CH₂Cl₂ and chloranil solution and then in K₂S₂O₈, gave a flexible adherent blue-black film on the rubber surface. The cut surface was clear blue/black. Polypyrrole was present inside the whole sample.

### Example 35

### Preparation of Rubber-Polypyrrole Materials Using Pyrrole and Chloranil: Comparison of Polymerizing Reagents

A rubber substrate was soaked in pyrrole containing dissolved chloranil. The latter solution became brown, presumably because it was oxidized partially. The substrate was then soaked in aqueous, saturated K₂S₂O₈ and 1.0 molar HCl. The polymerization on the rubber surface was fast. A good smooth black, adherent surface coat formed. The aqueous solution remained clear.

### Example 36

### Preparation of Rubber-Polypyrrole Materials Using Pyrrole, Chloranil, and DMSO: Comparison of Polymerizing Reagents

A rubber substrate was soaked in a DMSO solution of pyrrole (1:1) containing dissolved chloranil. The pyrrole and chloranil solution became brown presumably because it was oxidized partially. The substrate was then soaked in the following solutions: saturated, aqueous K₂S₂O₈ and 0.5 mol/l CCl₃COOH; 90 vol. % of saturated, aqueous K₂S₂O₈ and 10 vol. % of concentrated HCl; 0.05 mol/l HTSA in 1 molar aqueous HCl saturated with K₂S₂O₈; 1 mol/l, aqueous HCl in 1:1 half saturated, aqueous K₂S₂O₈ and half saturated, aqueous PSSA; half saturated, aqueous K₂CrO₄ and 0.05 mol/l CCl₃COOH; half saturated, aqueous K₂CrO₄ and 0.05 mol/l HTSA and 1 mol/l HCl; 1/10^{th} saturated, aqueous FeCl₃ and 1 mol/l HCl; 1/10^{th} saturated, aqueous FE₂(SO₄)₃ and 0.1 mol/l H₂SO₄; or 1/10^{th} saturated, aqueous K₃(FeCN)₆ and 1 mol/l HCl. The solution of K₂S₂O₈ and CCl₃COOH gave a black adherent film. The rubber was flexible. In the solution of K₂S₂O₈ and HCl, polymerization on the surface was fast and a good looking black, adherent coating was produced. The rubber was flexible. After 1 hour of oxidation in this aqueous K₂S₂O₈ and HCl solution, the cut surface was light gray. The cut surface, then was replaced in aqueous K₂S₂O₈ and HCl and rapidly became black. The rubber was flexible. The K₂S₂O₈ and HCl and HTSA solution produced a few black granules on an adherent, black surface. The rubber was flexible. The K₂S₂O₈ and HCl and PSSNa solution produced a good looking, black adherent coating. The substrate was white inside when freshly cut. The rubber was flexible. In the K₂Cr₂O₇ and CCl₃COOH solution, polymerization on the surface was fast and a black, adherent coating was produced. The rubber was flexible and the cut surface was dark. The black coating vanished when the rubber was held for a long time in the K₂Cr₂O₇ and CCl₃COOH solution. The K₂Cr₂O₇ and HCl and HTSA solution produced a yellowish-dark coating on the rubber surface. The cut surface was white inside, but it appeared that there has been some penetration by the black coating below the surface. The rubber was flexible. The FeCl₃ and HCl solution yielded a surface covered with a powdery black, adherent coating. The fresh cut surface was white. The rubber was flexible. polymerization medium yielded a matrix having the best conductivity compared to the other polymerization media used in Example 28. For Fe₂(SO₄)₃ and H₂SO₄, all aspects were inferior to results in Example 28. For K₃Fe(CN)₆ and HCl, the surface was covered with a powdery black and poorly adherent coating. The fresh cut surface was white. The rubber was flexible.

### Example 37

### Preparation of Rubber-Polypyrrole Materials Using Pyrrole and Toluene: Comparison of Polymerizing Reagents

A rubber substrate was soaked in a 1:1 mixture of pyrrole and toluene. Then, the substrate was soaked in the following solutions: 30% H₂O₂; 0.05 mol/l HTSA in 1 molar aqueous HCl saturated with K₂S₂O₈; saturated, aqueous K₂S₂O₈ and 0.05 mol/l HTSA; saturated, aqueous K₂CrO₄; half saturated, aqueous K₂CrO₄ and 0.05 mol/l HTSA and 1 mol/l HCl; half saturated, aqueous K₂CrO₄ and 0.05 mol/l HTSA; saturated, aqueous K₂S₂O₈ and 0.5 mol/l CCl₃COOH; or half saturated, aqueous K₂CrO₄ and 8 mol/l CH₃COOH. This procedure produced substrates with better conductivity and blacker cut surfaces than all the other soaking procedures with pure pyrrole, 1:1 pyrrole and acetone, or methylene chloride. In H₂O₂, an adherent black coating was produced. The rubber was flexible. The fresh cut surface was not black. The K₂S₂O₈ and HCl and HTSA solution gave an adherent black coat. The rubber was flexible. In the K₂S₂O₈ and HTSA solution, an adherent black coating was produced. The fresh cut surface was brown/black, showing that some polypyrrole had formed inside. The rubber was flexible. In the K₂Cr₂O₇ solution, there was no visible reaction with using relatively colorless pyrrole to make the pyrrole-toluene mixture. However, if air-oxidized pyrrole (light brown in color) was used, an adherent black coating formed on the rubber. The rubber was flexible. The fresh cut surface showed some dark color. A duplicate sample was electrochemically covered with copper from acid copper sulfate solution. Using the K₂Cr₂O₇ and HCl and HTSA solution gave a black coating that was powdery. The rubber was flexible. The fresh cut surface of a freshly polymerized sample that had been stored for a few months in the air was dark. Using the solution of K₂Cr₂O₇ and HTSA gave a black coating that was glossy, patchy (and rough), and nonadherent. The rubber was flexible. The fresh cut surface was dark (before cutting the rubber, the freshly polymerized sample had been stored for a few months in the air). The CH₃COOH and K₂S₂O₈ solution gave an adherent black coating with slight amount of black powder on it. The rubber was flexible. The cut surface had a rubber color. With the CH₃COOH and K₂Cr₂O₇ solution, an adherent black coat with slight amount of black powder was produced. The rubber was flexible. The cut surface had a rubber color. It was a poor conductor.

### Example 38

### Preparation of Rubber-Polypyrrole Materials Using 0.05 mol/l HTSA in 1:1 Pyrrole in Toluene: Comparison of Polymerizing Reagents

A rubber substrate was soaked in a 0.05 mol/l HTSA solution in 1:1 pyrrole and toluene and then soaked in the following solutions: saturated, aqueous K₂S₂O₈; saturated, aqueous K₂S₂O₈ and 0.05 mol/l HTSA; saturated, aqueous K₂CrO₄; half saturated, aqueous K₂CrO₄ and 1 mol/l HCl; 1/10^{th} saturated, aqueous FeCl₃ and 1 mol/l HCl; or 1/10^{th} saturated, aqueous Fe₂(SO₄)₃ and 1 mol/l HCl. An adherent black coating was produced in the saturated, aqueous K₂S₂O₈ solution. The rubber was flexible. This rubber sample soaked for 2 hours in the 1:1 (pyrrole in toluene) and HTSA mixture. The cut surface was white. A second rubber sample was soaked overnight in the 1:1 (pyrrole in toluene) and HTSA solution and the cut surface was not brown. The K₂S₂O₈ and HTSA solution gave an adherent black coating. The rubber was flexible. The cut surface was white. Using the K₂Cr₂O₇ solution, an adherent black coating was produced. The rubber was flexible. This rubber sample was then again soaked in dichromate. After two weeks in the dichromate solution the black coating vanished. Using the K₂Cr₂O₇ and HCl solution, an adherent black coat that was rough and oily was produced. The rubber was flexible. The cut surface was white. Another sample of a different rubber, but treated the same way and held in air for several months, had an adherent black coat and the rubber was flexible. The cut surface was brown. Using the FeCl₃ and HCl saturated solution gave an adherent black coating. The rubber was flexible. The cut surface had an off white color. The freshly cut sample was grayish/pink. The Fe₂(SO₄)₃ and HCl solution produced an adherent black coat. The rubber was flexible. The cut surface had an off white color. After 2 weeks, the fresh cut surface showed signs of further polymerization, i.e., turned darker.

### Example 39

### Preparation of Rubber-Polypyrrole Materials Using Pyrrole, Toluene, and DMSO: Comparison of Polymerizing Reagents

A rubber substrate was soaked in a solution of 1:1:1 pyrrole, toluene, and DMSO, and then soaked in the following solutions: half saturated, aqueous K₂CrO₄ and 1 mol/l HCl, or half saturated, aqueous K₂CrO₄ and 0.05 mol/l HTSA and 1 mol/l HCl. With the solution of K₂Cr₂O₇ and HCl, an adherent black coat was produced. The rubber was flexible and the cut surface was off-white. Using the solution of K₂Cr₂O₇ and HCl and HTSA gave an adherent black coat. The rubber was flexible. The surface was cut two months after preparing the sample, and the cut surface was brown.

### Example 40

### Preparation of Polypyrrole-Matrix Materials Using Toluene and HTSA: Transporting a Polymerizing Reagent

Examples 40-47 were performed by soaking the matrix initially in a mixture that did not contain pyrrole, then drying the matrix, and then subjecting it to one or more additional steps.

A rubber substrate was soaked in a solution comprised of 0.05 mol/l dissolved HTSA in toluene, dried, and then soaked in pyrrole. The substrate was then soaked in half saturated, aqueous K₂CrO₄ and 1 mol/l HCl. An adherent black coat was observed and the rubber was flexible. The cut surface had some evidence of polypyrrole.

A rubber substrate was soaked in a solution comprised of 0.05 mol/l dissolved HTSA in toluene, dried, and then soaked in 0.05 mol/l HTSA in pyrrole. The substrate was then soaked in half saturated, aqueous K₂CrO₄ and 0.05 mol/l HTSA. An adherent black coat was observed and the rubber was flexible. The cut surface had some evidence of polypyrrole.

### Example 41

### Preparation of Polypyrrole-Matrix Materials Using Toluene and PSSNa: Transporting a Polymerizing Reagent

A rubber sample was soaked in 0.05 mol/l PSSNa in toluene, and then soaked in pyrrole. The sample was then soaked in a solution comprised of 90 vol. % of saturated, aqueous K₂S₂O₈ and 10 vol. % of concentrated HCl. An adherent black coat was observed and the rubber was flexible. The cut surface was blackish.

### Example 42

### Preparation of Polypyrrole-Matrix Materials Using Toluene and Chloranil: Transporting a Polymerizing Reagent

Rubber, vinyl, and FEP samples were soaked overnight in a solution comprised of 0.05 mol/l chloranil dissolved in toluene, dried, and then soaked in pyrrole. The rubber sample had a black adherent coat and was flexible. The cut surface was dark. The vinyl sample had a dark brown adherent coat. It was hard, but cut easily. The cut surface was initially dark and after a week it became black.

The samples were then soaked in a solution comprised of 90 vol. % of saturated, aqueous K₂S₂O₈ and 10 vol. % of concentrated HCl. The rubber sample had an adherent black coat and was flexible. The cut surface was black. The vinyl was totally black throughout and it was hard. A fresh sample had good conductivity. The FEP sample had a transparent yellowish/brown color throughout.

### Example 43

### Preparation of Polypyrrole-Matrix Materials Using Toluene, PSSNa, and Chloranil: Transporting a Polymerizing Reagent

Rubber, vinyl, polypropylene, and FEP samples were soaked overnight in 0.05 mol/l chloranil and 0.05 mol/l PSSNa in toluene, dried, and then were soaked in pyrrole. The samples were then soaked in a solution comprised of 90 vol. % of saturated, aqueous K₂S₂O₈ and 10 vol. % of concentrated HCl. The rubber sample had a black adherent flexible coat and the cut surface was brown. When soaked again in the toluene and PSSNa and chloranil solution and then in the pyrrole, the rubber became swollen, and was black throughout. The rubber tore easily. The vinyl sample was black throughout and hard. Polypyrrole was formed all the way through the vinyl. The polypropylene sample had a black surface coating. The FEP sample was light brown (purple when freshly made) and was translucent. These samples showed good results in terms of formation of polypyrrole throughout the matrix, but after total oxidation the samples surfaces became non-conducting and showed only cut surface conductivity.

### Example 44

### Preparation of Polypyrrole-Matrix Materials Using CH₂Cl₂ and HTSA: Transporting a Polymerizing Reagent

Rubber, vinyl, and polypropylene samples were soaked overnight in 0.05 mol/l PSSNa and 0.05 mol/l chloranil in toluene, dried, and then soaked in pyrrole. The samples were then soaked in a solution comprised of 90 vol. % of saturated, aqueous K₂S₂O₈ and 10 vol. % of concentrated HCl. The rubber sample had an adherent black coat and was flexible. The cut surface was brown. The vinyl sample had an adherent black coat. The vinyl sample was hard and brittle when cut and the cut surface was brown with light hard flakes inside. For the polypropylene sample, there was a thin, black, and smooth very adherent surface film. The cut surface was clear (no visible polypyrrole) and glassy.

### Example 45

### Preparation of Polypyrrole-Matrix Materials Using CH₂Cl₂ and PSSNa: Transporting a Polymerizing Reagent

A rubber sample was soaked overnight in a solution comprised of 0.05 mol/l PSSNa dissolved in CH₂Cl₂, dried, and then soaked in pyrrole. The sample was then soaked in a solution comprised of 90 vol. % of saturated, aqueous K₂S₂O₈ and 10 vol. % of concentrated HCl. The rubber sample had a black adherent film and was flexible. The cut surface was light colored, not black.

### Example 46

### Preparation of Polypyrrole-Matrix Materials Using CH₂Cl₂ and CCl₃COOH: Transporting a Polymerizing Reagent

Rubber and polypropylene samples were soaked overnight in a solution comprised of 0.5 mol/l CCl₃COOH dissolved in CH₂Cl₂, dried, and soaked overnight in pyrrole. Then the samples were soaked in a solution comprised of 90 vol. % of saturated, aqueous K₂S₂O₈ and 10 vol. % of concentrated HCl. The rubber sample had a dark brown film on the surface. The rubber sample was not elastic and was easily torn. The cut surface was dark brown. The polypropylene sample had a black, dense, and smooth adherent coat on the surface. The cut surface was clear and yellowish/brown. The polypropylene had a good conductivity.

### Example 47

### Preparation of Polypyrrole-Matrix Materials Using CH₂Cl₂ and Chloranil: Transporting a Polymerizing Reagent

Rubber and vinyl samples were soaked overnight in a solution comprised of 0.02 mol/l chloranil dissolved in CH₂Cl₂, dried, then soaked overnight in pyrrole. The samples were then dried and soaked overnight in a solution comprised of 0.02 mol/l chloranil dissolved in CH₂Cl₂. The vinyl sample had a smooth black coat on the surface and clear uniform black color inside as well. Initially, the vinyl was soft and swollen after the initial polymerization but after several weeks it became harder and blacker.

The samples were then soaked in saturated, aqueous K₂S₂O₈ or a solution comprised of 90 vol. % of saturated, aqueous K₂S₂O₈ and 10 vol. % of concentrated HCl. Using the saturated, aqueous solution of K₂S₂O₈, the rubber sample had an adherent black coating and was flexible. The cut surface was dark. The vinyl had an adherent black surface. The vinyl was hard. The cut surface was dark and glassy. With the K₂S₂O₈ and HCl solution, the rubber had a black adherent coat and was flexible. The cut surface was dark brown and the rubber was a good conductor on preparation. The cut surface of the rubber turned black in air. The vinyl sample had a black, shiny adherent coat. The vinyl was very stiff, but not hard and the cut surface was brown. It was a good conductor on preparation.

### Example 48

### Preparation of Polyaniline-Matrix Materials: Comparison of Polymerizing Reagents

The matrices, rubber and vinyl, were soaked overnight in aniline, and then soaked in a solution comprised of 0.02 mol/l chloranil dissolved in CH₂Cl₂. The substrates were then soaked in a solution comprised of 90 vol. % of saturated, aqueous K₂S₂O₈ and 10 vol. % of concentrated HCl. The rubber sample showed a black, adherent coating. The rubber was flexible and the cut surface was black. The vinyl sample showed a black, adherent coating. The vinyl was hard and the cut surface was black.

### Example 49

### Preparation of Polyaniline-Matrix Materials Using HTSA: Comparison of Polymerizing Reagents

A rubber substrate was soaked overnight in aniline and HTSA and then soaked in the following solutions: saturated, aqueous K₂S₂O₈; 90 vol. % of saturated, aqueous K₂S₂O₈ and 10 vol. % of concentrated HCl; saturated, aqueous K₂S₂O₈ and 0.05 mol/l HTSA; 0.05 mol/l HTSA in 1 molar aqueous HCl saturated with K₂S₂O₈; 1/10^{th} saturated, aqueous FeCl₃ and 1 mol/l HCl; 1/10^{th} saturated, aqueous Fe₂(SO₄)₃ and 0.1 mol/l H₂SO₄; or 1/10^{th} saturated, aqueous K₃(FeCN)₆ and 1 mol/l HCl. For the saturated, aqueous K₂S₂O₈ solution, a smooth, dark brown adherent coating was observed and the rubber was flexible. The cut surface was dark brown. With the K₂S₂O₈ and HCl solution, the surface was gray/black and the rubber was partially flexible. The cut surface was black. Using the K₂S₂O₈ and HTSA solution, a powdery black overlayer on an adherent black coating was produced. The rubber was flexible and the cut surface was black. With the K₂S₂O₈ and HCl and HTSA solution, a gray surface was observed. The rubber was flexible and the cut surface was black. Using the FeCl₃ and HCl solution gave barely visible black color on cut edges, but not elsewhere. With the Fe₂(SO₄)₃ and H₂SO₄ solution, there was no visible black color anywhere. The K₃Fe(CN)₆ and HCl solution produced a dull black surface coating. The rubber was flexible and the cut surface was white with a tinge of brown.

### Example 50

### Preparation of Polyaniline-Matrix Materials Using CH₃COCH₃: Comparison of Polymerizing Reagents

The substrate, rubber, was soaked overnight in 1:1 aniline and CH₃COCH₃. Some aqueous solutions of Example 49 were used for polymerization. In all cases the results were better than in Example 49. Persulfate was better than dichromate, which was better than peroxide.

### Example 51

### Preparation of Polyaniline-Matrix Materials Using PSSNa: Comparison of Polymerizing Reagents

The substrate, rubber, was soaked overnight in aniline and 0.01 mol/l PSSNa. The substrate was then soaked in the following solutions: 1/10^{th} saturated FeCl₃; 1/10^{th} saturated, aqueous Fe₂(SO₄)₃ and 0.1 mol/l H₂SO₄; or 1/10^{th} saturated, aqueous K₃(FeCN)₆ and 1 mol/l HCl. The FeCl₃ solution gave no visible black colored film, except on cut edges. For the Fe₂(SO₄)₃ and H₂SO₄ solution, no visible black colored film was observed. The solution of K₃Fe(CN)₆ and HCl gave a non-uniform bluish coating on the surface (which could be Prussian blue). The rubber was flexible and the cut surface was white.

### Example 52

### Preparation of Polyaniline-Matrix Materials Using DMSO and Chloranil: Comparison of Polymerizing Reagents

The substrates, rubber and vinyl, were soaked overnight in a solution comprised of a 1:1 mixture of aniline and DMSO saturated with chloranil. The substrates were then soaked in a solution comprised of 90 vol. % of saturated, aqueous K₂S₂O₈ and 10 vol. % of concentrated HCl, a solution comprised of half saturated, aqueous K₂CrO₄ and 1 mol/l HCl, a solution comprised of half saturated, aqueous K₂CrO₄ and 0.05 mol/l CCl₃COOH, or a solution comprised of 1/10^{th} saturated, aqueous FeCl₃ and 1 mol/l HCl. For the solution of K₂S₂O₈ and HCl, the rubber sample showed a black adherent coating and the rubber was flexible. The cut surface had an off-white central region, with black edges near each surface. The vinyl sample showed a black adherent coating. The vinyl was hard. For the K₂Cr₂O₇ and HCl solution, the rubber sample showed a thick black adherent coating and the rubber was flexible. The cut surface was dark white with thin black layers adjacent to the exterior surface. Using the solution of K₂Cr₂O₇ and CCl₃COOH, the rubber samples (2 samples) showed a black adherent coating and the rubber was flexible. The cut surface was white with thin black layers adjacent to the exterior surface. The vinyl sample had a rough, black fairly adherent coating. The vinyl was hard and the cut surface was clear (not black). With the FeCl₃ and HCl solution, there was no visible black coating.

### Example 53

### Preparation of Polyaniline-Matrix Materials Using Chloranil, DMSO, and HTSA: Comparison of Polymerizing Reagents

A rubber sample was soaked overnight in a solution comprised of 0.02 mol/l chloranil and 0.02 mol/l HTSA dissolved in a 1:1 mixture of aniline and DMSO. The sample was then soaked in a solution comprised of 1/10^{th} saturated, aqueous K₃(FeCN)₆ and 1 mol/l HCl. A black adherent coating was observed. The rubber was flexible and the cut surface was “off white”.

### Example 54

### Preparation of Polyaniline-Matrix Materials Using Toluene and HTSA: Comparison of Polymerizing Reagents

A rubber sample was soaked overnight in a solution comprised of 0.02 mol/l HTSA dissolved in a 1:1 mixture of aniline and CH₂Cl₂. The sample was then soaked in saturated, aqueous K₂Cr₂O₇ or a solution of saturated, aqueous K₂Cr₂O₇ and 1.0 mol/l HCl. For the K₂Cr₂O₇ solution, no visible black coating was observed. For the K₂Cr₂O₇ and HCl solution, the rubber had a dark coating with yellow overcast. The rubber was flexible and the cut surface was black and showed corrugation on its periphery when the rubber was stretched.

### Example 55

### Preparation of Polyaniline-Matrix Materials Using Toluene and PSSNa: Transporting a Polymerizing Reagent

The substrates, rubber and vinyl, were soaked overnight in a solution comprised of 0.05 mol/l PSSNa dissolved in toluene, dried, and then soaked in aniline. The substrates were then soaked in a solution comprised of 90 vol. % of saturated, aqueous K₂S₂O₈ and 10 vol. % of concentrated HCl The rubber sample showed a black adherent coating and the rubber was flexible. The cut surface was black (not deep black). The vinyl sample had a black adherent coating, was hard, and its cut surface was glossy black.

The substrates, rubber, vinyl, polypropylene, and FEP, were then soaked again overnight in aniline and then in a solution comprised of 90 vol. % of saturated, aqueous K₂S₂O₈ and 10 vol. % of concentrated HCl. The rubber sample had a black adherent coating, was flexible, and its cut surface was brown. The vinyl sample had a black adherent coating, was hard, and its cut surface was glossy black. The polypropylene sample had a black adherent coating, was hard, and its cut surface was black. The FEP was transparent yellow.

### Example 56

### Preparation of Polyaniline-Matrix Materials Using CH₂Cl₂ and HTSA: Comparison of Polymerizing Reagents

A rubber sample was soaked overnight in a solution comprised of 0.02 mol/l HTSA dissolved in a 1:1 mixture of aniline and CH₂Cl₂. The sample was then soaked in a solution comprised of 90 vol. % of saturated, aqueous K₂S₂O₈ and 10 vol. % of concentrated HCl. A black adherent coating was observed. The rubber was flexible and its freshly cut surface was dark, almost black. After aging in air, the cut surface turned black.

### Example 57

### Preparation of Polyaniline-Matrix Materials Using CH₂Cl₂ and HTSA: Transporting a Polymerizing Reagent

Rubber, vinyl, and polypropylene samples were soaked overnight in a solution comprised of CH₂Cl₂ and 0.02 mol/l HTSA. After air-drying they were then soaked in aniline overnight. The samples were then soaked in a solution comprised of 90 vol. % of saturated, aqueous K₂S₂O₈ and 10 vol. % of concentrated HCl. The rubber sample had a black adherent coating, was flexible, and its cut surface was black. The vinyl sample had a black adherent coating, was hard, and its cut surface was black. The polypropylene sample had a black adherent coating, was hard, and its cut surface was black.

### Example 58

### Preparation of Polyaniline-Matrix Materials Using CH₂Cl₂ and PSSNa: Transporting a Polymerizing Reagent

A rubber sample was soaked overnight in a solution comprised of CH₂Cl₂ and 0.05 mol/l PSSNa. After air-drying, the rubber was then soaked in aniline overnight. The substrate was then soaked in a solution comprised of 90 vol. % of saturated, aqueous K₂S₂O₈ and 10 vol. % of concentrated HCl. A black adherent coating was observed. The rubber was stiff, but had some flexibility. The cut surface was black.

### Example 59

### Preparation of Polyaniline-Matrix Materials Using CH₂Cl₂+CCl₃COOH: Transporting a Polymerizing Reagent

Rubber and vinyl samples were soaked overnight in a solution comprised of 0.5 mol/l CCl₃COOH dissolved in CH₂Cl₂. After air drying, they were then soaked in aniline overnight. The samples were then soaked in a solution comprised of 90 vol. % of saturated, aqueous K₂S₂O₈ and 10 vol. % of concentrated HCl. The rubber sample showed black particles on an adherent black surface. The rubber was flexible and the cut surface was black. The vinyl sample showed an adherent black layer. The vinyl was flexible and the cut surface was black.

### Example 60

### Preparation of Polyaniline-Matrix Materials Using CH₂Cl₂ and Chloranil: Transporting a Polymerizing Reagent

A rubber sample was soaked overnight in a solution comprised of 0.02 mol/l chloranil dissolved in CH₂Cl₂. After air-drying, the rubber was then soaked in aniline. A black adherent coating was observed. The rubber was flexible and the cut surface was slightly darkened, but was not black. The color was closer in shade to white.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A polymer-matrix material comprising a non-ionic solid matrix and a polymer, wherein the polymer is present on a surface of the non-ionic solid matrix and within an interior bulk of the non-ionic solid matrix.

2. A polymer-matrix material according to claim 1, wherein the non-ionic solid matrix is an organic material.

3. A polymer-matrix material according to claim 2, wherein the non-ionic solid matrix is rubber, polypropylene, vinyl, fluorinated ethylene propylene, textile fibers, animal tissue, or silica gel.

4. A polymer-matrix material according to claim 1, wherein the polymer is an electrically conducting polymer or an electroactive polymer.

5. A polymer-matrix material according to claim 4, wherein the polymer is polypyrrole or polyaniline.

6. A polymer-matrix material according to claim 1 comprising about 99-1 wt. % non-ionic solid matrix and about 1-99 wt. % polymer.

7. A method for forming a polymer on and within a non-ionic solid matrix comprising:
transporting a polymer precursor on and into the non-ionic solid matrix and
exposing the non-ionic solid matrix to a polymerizing reagent under conditions effective to polymerize the polymer precursor on and within the non-ionic solid matrix.

8. A method according to claim 7, wherein the non-ionic solid matrix is an organic material.

9. A method according to claim 8, wherein the non-ionic solid matrix is rubber, polypropylene, vinyl, fluorinated ethylene propylene, textile fibers, animal tissue, or silica gel.

10. A method according to claim 7, wherein the polymer precursor is pyrrole or aniline.

11. A method according to claim 7, wherein said transporting is carried out by osmotic action, capillary action, or partitioning.

12. A method according to claim 7, wherein the polymerizing reagent is H₂O₂, K₂S₂O₈, K₂Cr₂O₇, FeCl₃, or tetrachloro-1,4 benzoquinone.

13. A method according to claim 7, wherein from about 1% to 100% of the polymer precursor is polymerized.

14. A method according to claim 7 further comprising:
exposing the non-ionic solid matrix to an initial polymerizing reagent prior to said exposing the non-ionic solid matrix to a polymerizing reagent.

15. A method for forming a polymer on and within a non-ionic solid matrix comprising:
transporting a first polymerizing reagent on and into the non-ionic solid matrix and
exposing the non-ionic solid matrix to a polymer precursor under conditions effective to polymerize the polymer precursor within the non-ionic solid matrix.

16. A method according to claim 15, wherein the non-ionic solid matrix is an organic material.

17. A method according to claim 16, wherein the non-ionic solid matrix is rubber, polypropylene, vinyl, fluorinated ethylene propylene, textile fibers, animal tissue, or silica gel.

18. A method according to claim 15, wherein the polymer precursor is pyrrole or aniline.

19. A method according to claim 15, wherein said transporting is carried out by osmotic action, capillary action, or partitioning.

20. A method according to claim 15, wherein the first polymerizing reagent is H₂O₂, K₂S₂O₈, K₂Cr₂O₇, FeCl₃, or tetrachloro-1,4 benzoquinone.

21. A method according to claim 15, wherein from about 1% to 100% of the polymer precursor is polymerized.

22. A method according to claim 15 further comprising:
after said exposing, exposing the non-ionic solid matrix to a second polymerizing reagent.
